(19) United States
(12) Patent Application Publication
(10) Pub. No.: US 2007/0133687 A1
(43) Pub. Date: Jun. 14, 2007

(54) Motion compensation method

(76) Inventors: Steffen Wittmann, Morfelden-Walldorf (DE); Thomas Wedi, Gross-Umstadt (DE); Satoshi Kondo, Yawata-shi (JP)

Correspondence Address: WENDEROTH, LIND & PONACK L.L.P., 2033 K. STREET, NW, SUITE 800, WASHINGTON, DC, 20006, US

(21) Appl. No.: 10/590,524

(22) PCT Filed: Jul. 6, 2005
(86) PCT No.: PCT/JP05/12873

§ 371 Date: Aug. 24, 2006

(30) Foreign Application Priority Data
Jul. 13, 2004 (EP) 04016437.8

(51) Int. Cl. H04N 11/04; H04N 7/12

(52) U.S. Cl. 375/240.17; 375/240.26

(57) ABSTRACT

A motion compensation method for achieving the reduction of operation workload and the simplification of a hardware configuration includes: interpolation having (i) a first calculation step (S100) of calculating base values of sub-pixel values by multiplying coefficients with pixel values of pixels included in a reference picture and (ii) a first rounding step (S102) of deriving sub-pixel values of sub-pixels by rounding the base values calculated in the first calculation step (S100) in stead of directly using the base values in calculating other sub-pixel values; and motion compensation (S110) of the reference picture that has interpolated sub-pixels with the derived sub-pixel values.

### TECHNICAL FIELD

The present invention relates to a motion compensation method for interpolating sub-pixels into a reference picture and for performing motion compensation based on the interpolated reference picture.

### BACKGROUND ART

Moving pictures are being adopted in an increasingly number of applications ranging form video telephony and video conferencing to DVD and digital television. When moving pictures are transmitted, a substantial amount of data has to be sent through conventional transmission channels of a limited available frequency bandwidth. In order to transmit the digital data through the limited channel bandwidth, it is inevitable to compress or reduce the volume of the transmission data.

In order to enable inter-operability between systems designed by different manufactures of any given application, video-coding standards have been developed for compressing the amount of video data. The coding approach underlying most of these standards consist of the following main steps:

(1) Dividing each video frame into blocks of pixels so that processing of the video frame can be conducted at a block level;

(2) Reducing spatial redundancies within a video frame by subjecting video data of each block to transform, quantization and entropy coding;

(3) Exploiting temporal dependencies between blocks of subsequent frames in order to only transmit differentials between subsequent frames.

Temporal dependencies between blocks of subsequent frames are determined by employing a motion estimation and compensation technique. For any given block, a search is performed in previously coded and transmitted frames to determine a motion vector which will be used by the coding apparatus and the decoding apparatus to predict the image data of a block.

An example configuration of a video coding apparatus is illustrated in FIG. 1. The shown video coding apparatus generally denoted with reference numeral 900 includes: a transform/quantization unit 920 to output quantized transform coefficients QC by transforming spatial image data to the frequency domain and quantizing the transformed image data; an entropy coding unit 990 for performing entropy coding (variable length coding) of the quantized transform coefficients QC and outputting the bit stream BS; and a video buffer (not shown) for adopting the compressed video data having a variable bit rate to a transmission channel which may have a fixed bit rate.

The coding apparatus shown in FIG. 1 employs a DPCM (Differential Pulse Code Modulation) by only transmitting differentials between subsequent fields or frames. A subtractor 910 obtains these differentials by receiving the video data to be coded as an input signal IS and subtracting the previous image indicated by a prediction signal PS therefrom. The previous image is obtained by decoding the previously coded image. This is accomplished by a decoding apparatus which is incorporated into video coding apparatus 900. The decoding apparatus performs the coding steps in a reverse manner. More specifically, the decoding apparatus includes: an inverse quantization/transform unit 930, and an adder 935 for adding the decoded differential (differential decoding signal DDS) to the previously decoded picture (prediction signal PS) in order to produce the image as will be obtained on the decoding side.

In motion compensated DPCM, a current frame or field is predicted from image data of a previous frame or field based on an estimation of the motion between the current and the previous images. Such estimated motion may be described in terms of 2-dimensional motion vectors representing the displacement of pixels between the previous and the current images. Usually, motion estimation is performed on a block-by-block basis. An example of the division of the current image into plurality of blocks is illustrated in FIG. 2.

During motion estimation, a block of a current frame is compared with blocks in previous frames until a best match is determined. Based on the comparison results, an inter-frame displacement vector for the whole block can be estimated for the current frame. For this purpose, a motion estimation unit 970 is incorporated into the coding apparatus together with the corresponding motion compensation unit 960 included into the decoding path.

The video coding apparatus 900 of FIG. 1 performs operations as follows. A given video image indicated by an input signal IS is divided into a number of small blocks, usually denoted as “macro blocks”. For example, video image shown in FIG. 2 is divided into a plurality of macro blocks, each of which usually having a size of 16×16 pixels.

When coding the video data of an image by only reducing spatial redundancies within the image, the resulting frame is referred to as an I-picture. I-pictures are typically coded by directly applying the transform to the macro blocks of a frame. I-pictures are large in size as no temporal information is exploited to reduce the amount of data.

In order to take advantage of temporal redundancies that exist between successive images, a prediction coding between subsequent fields or frames is performed based on motion estimation and compensation. When a selected reference frame in motion estimation is a previously coded frame, the frame to be coded is referred to as a P-picture. In case both, a previously coded frame and a future frame are chosen as reference frames, the frame to be coded is referred to as B-picture.

Although the motion compensation has been described to be based on a 16×16 macro block, motion estimation and compensation can be performed using a number of different block sizes. Individual motion vectors may be determined for blocks having 4×4, 4×8, 8×4, 8×8, 8×16, 16×8, or 16×16 pixels. The provision of small motion compensation blocks improves the ability to handle fine motion details.

Based on the results of the motion estimation operation, the motion compensation operation provides a prediction based on the determined motion vector. The information contained in a prediction error block resulting from the predicted block is then transformed into transform coefficients in transform/quantization unit 920. Generally, a 2-dimensional DCT (Discrete Cosine Transform) is employed. The resulting transform coefficients are quantized and finally entropy coded (VLC) in entropy coding unit 990.

A decoding apparatus receives the transmitted bit stream BS of compressed video data and reproduces a sequence of coded video images based on the received data. The configuration of the decoding apparatus corresponds to that of the decoding apparatus included in the coding apparatus shown in FIG. 1. A detailed description of the configuration of the decoding apparatus is therefore omitted.

In order to improve the accuracy of motion compensation, a sub-pixel accuracy of reference frames is widely used. For example, ½ sub-pixel accuracy motion compensation is used in the MPEG-2 format.

In order to further increase the motion vector accuracy and coding efficiency, a ⅓ and a ⅙ sub-pixel vector accuracies have been proposed in Patent Literature EP 1 073 276.

The motion vector accuracy and coding efficiency can further be increased by applying interpolation filters in motion estimation and compensation yielding ⅛ sub-pixel displacements. However, such a sub-pixel resolution requires high computation complexity, in particular, calculation registers having a length of up to 25 bits.

Such a complex implementation may be based on a 2-step approach. In the first step a ¼ sub-pixel image employing an 8-tap filter is calculated. In second step a ⅛ sub-pixel is obtained based on the ¼ sub-pixel image by employing a bilinear filtering.

The filtering operation for generating the image with the ¼ sub-pixel accuracy includes the steps of horizontal and subsequent vertical filtering. The horizontal interpolation may be performed based on the following Equations (1) to (3):
h₁=−3·A₄+12·B₄−37·C₄+229·D₄+71·E₄−21F₄+6·G₄−1·H₄ (1)
h₂=−3·A₄+12−B₄−39·C₄+158·D₄+158·E₄−39·F₄+12·G₄−3·H₄ (2)
h₃=−1·A₄+6·B₄−21·C₄+71·D₄+229·E₄−37·F₄+12·G₄−3·H₄ (3)

In the above equation, h₁ to h₃ denote the ¼ sub-pixel values and Aₓ-Hₓ represent the original full-pel pixel values, namely, the pixels from the original image.

Coefficients applied to the above Aₓ-Hₓ are set in a way that the signal processing is performed preventing the occurrence of imaging by upsampling, in other words, unnecessary high frequency components generated through interpolation are eliminated.

The horizontal filtering is illustrated in FIG. 3. Eight-tap filtering is performed based on the pixel values of the original pixels 210 and the pixel values of the three intermediate pixels 220 are calculated in order to obtain a ¼ sub-pixel accuracy in the horizontal direction.

After the horizontal filtering has been completed, the resulting image data having a full-pel pixel accuracy in the vertical direction and a ¼ sub-pixel accuracy in the horizontal direction are subjected to vertical filtering. For this purpose, the following Equations (4) to (6) having coefficients which correspond to those of the above described horizontal filter are employed.
v₁=−3·D₁+12·D₂−37·D₃+229·D₄+71·D₅−21·D₆+6·D₇−1·D₈ (4)
v₂=−3·D₁+12·D₂−39·D₃+158·D₄+158·D₅−39·D₆+12·D₇−3·D₈ (5)
v₃=−1·D₁+6·D₂−21·D₃+71·D₄+229·D₅−37·D₆+12·D₇−3·D₈ (6)

In the above equations, v₁ to v₃ refer to the calculated vertical ¼ sub-pixel values and D₁, D₂, D₃, D₄, D₅, D₆, D₇. and D₈ represent the full-pel resolution pixels, namely, the pixel values of the original pixels 210.

Like in the case described above, coefficients applied to Dₓ are set in a way that the signal processing is performed preventing the occurrence of imaging by upsampling, in other words, unnecessary high frequency components generated through interpolation are eliminated.

The resulting pixel values have a length of up to 25 bits. In order to obtain image data in each of the pixel values fall into a predefined range of allowable pixel values, the calculation results are downshifted and rounded as illustrated. An example case of pixel value v₁ is shown by the following Equation (7):

$${v}_{1}^{′} = ( {v}_{1} + \frac{{256}^{2}}{2} ) >> 16 \qquad ( 7 )$$

Here, v₁ represents the pixel value resulting from the horizontal and vertical filtering, while v₁′ represents the downshifted pixel value. The downshifted pixel values are further clipped to the range of 0 to 255.

The vertical filtering is illustrated in FIG. 4. The pixel values of the pixels 230 obtained during vertical filtering complete the sub-pixel array illustrated by way of filtering example between original pixels D₄, D₅, E₄ and E₅.

After having the ¼ sub-pixel image completed, a ⅛ sub-pixel frame is calculated by applying a bilinear filtering to the ¼ sub-pixel resolution. In this manner, intermediate pixels are generated between each of the ¼ resolution pixels.

A bilinear filtering is applied in two steps and is illustrated by way of examples in FIG. 5 and FIG. 6. Starting from the ¼ sub-pixel resolution, FIG. 5 illustrates the application of a horizontal and vertical filtering. For this purpose, a mean value is calculated from the respective neighbouring pixel values in order to obtain an intermediate pixel value of a ⅛ sub-pixel resolution. When employing a binary representation for this processing, the following Equation (8) can be applied. Note that “>>1” in Equation (8) represents 1-bit downshifting.
A=(B+C+1)>>1 (8)

The remaining ⅛ sub-pixel values to be interpolated are calculated by diagonal filtering as illustrated in FIG. 6. It is a particular advantage of this approach that, in the bilinear filtering, the number of sub-pixel values stemming from multiple filtering is minimized as much as possible. For this purpose, it is preferable that only those pixel values, of the interpolated pixels, that are directly derived from original pixel values 210 are taken into account. In other words, those derived pixel values are the pixel values of the interpolated pixels located between the original pixels.

All intermediate pixel values can be calculated therefrom, in other words, from the pixel values of the original pixels 210 and the intermediate pixel values derived from the original pixel values, when additionally taking center pixel 240 of the sub-pixel array into account. The calculation operation for the additional ⅛ sub-pixel values is based on two of the ¼ sub-pixel resolution values, respectively. The individual pixel values taken into account for the calculation of an intermediate pixel value are illustrated in FIG. 6 by respective arrows. Each of the arrows shows two pixel values of pixels based on which each intermediate pixel value of the two is calculated. Depending on the distance of the pixels to be taken into account for interpolation, the following Equations (9) and (10) are employed:
D=(E+F+1)>>1 (9)
G=(3H+I+2)>>1 (10)

In the above equations, D and G represent new intermediate pixel values as illustrated in FIG. 6, and E, F, H and I represent the pixel values obtained from the ¼ resolution image. The additional values of “1” and “2” in the above equations only serve for correctly rounding the calculation results.

However, the above-described conventional motion compensation method requires to record a long operation value of 25 bits in the filtering process for ¼ sub-pixel interpolation. This causes a particular disadvantage of such an interpolation approach that long registers are needed resulting in high hardware complexity and computational effort.

The present invention is conceived in view of this drawback. An object of the present invention is to provide a motion compensation method for reducing operational workload and simplifying a hardware configuration.

### DISCLOSURE OF INVENTION

In order to achieve the above-described object, the motion compensation method of the present invention includes: interpolating sub-pixels in a reference picture; and performing motion compensation based on the interpolated reference picture, in the method, the interpolating including: a first calculation step of calculating base values which are bases of sub-pixel values of the sub-pixels by multiplying coefficients with pixel values of pixels included in the reference picture; and a first rounding step of deriving the sub-pixel values of the sub-pixels by rounding the base values calculated in the first calculation step instead of directly using the base values in calculating sub-pixel values of other sub-pixels; and the performing of motion compensation includes performing motion compensation based on the reference picture having the interpolated sub-pixels with the correspondingly derived sub-pixel values.

For example, in the conventional method, base values of sub-pixels that have been calculated are directly used in calculating sub-pixel values of other sub-pixels. However, in the present invention, the base values of sub-pixels that have been calculated in the first calculation step are rounded in stead of being directly used in calculating the sub-pixel values of other sub-pixel values. Therefore, even in the case where the sub-pixel values of the other sub-pixels are calculated using the base values rounded, the number of bits to be used in the calculation can be more reduced than in the conventional way. As a result, it becomes possible to reduce the operational workload and to simplify the hardware configuration.

Also, in a first aspect of the present invention, in the motion compensation method, the first calculation step may include calculating base values of sub-pixels to be interpolated in a first direction, and the first rounding step may include deriving sub-pixel values of the sub-pixels to be interpolated in the first direction by rounding the base values calculated in the first calculation step. At this time, in a second aspect of the present invention, in the motion compensation method, the interpolation may further include: a second calculation step of calculating, using the sub-pixel values of the sub-pixels derived in the first rounding step, base values of sub-pixels to be interpolated in a second direction that is different from the first direction; and a second rounding step of deriving the sub-pixel values of the sub-pixels to be interpolated in the second direction by rounding the base values calculated in the second calculation step.

In this way, in the process of calculating sub-pixel values of sub-pixels to be interpolated in the first direction and in the second direction, the number of bits to be used in the calculation can be reduced down to 16 bits from, for example, 25 bits needed in a conventional way.

Also, a fourth aspect of the present invention, in the motion compensation method, the first calculation step may include calculating the base values of three a-fourths sub-pixels using the following equations when eight pixel values of pixels arrayed in the first direction are represented as A, B, C, D, E, F, G and H respectively and the three a-fourths sub-pixel values are represented as h₁, h₂ and h₃ respectively:
h₁=−1·A+3·B−10·C+59·D+18·E−6·F+1·G−0·H;
h₂=−1·A+4·B−10·C+39·D+39·E−10·F+4·G−1·H; and
h₃=−0·A+1·B−6·C+18D+59·E−10·F+3·G−1·H.
Here, in a fifth aspect of the present invention, in the motion compensation method, the second calculation step may include calculating the base values of three a-fourths sub-pixels using the following equations when eight pixel values of pixels arrayed in the second direction are represented as D₁, D₂, D₃, D₄, D₅, D₆, D₇ and D₈ respectively and the three a-fourths sub-pixel values are represented as v₁, v₂ and v₃ respectively:
v₁=−3·D₁+12·D₂−37·D₃+229·D₄+71·D₅−21·D₆+6·D₇−1·D₈;
v₂=−3·D₁+12·D₂−39·D₃+158·D₄+158·D₅−39·D₆+12·D₇−3·D; and
v₃=−1·D₁+6·D₂−21·D₃+71·D₄+229·D₅−37·D₆+12·D₇−3·D₈.

In this way, the coefficients used in calculating sub-pixel values of sub-pixels are smaller than the conventional coefficients. This makes it possible to further reduce the number of bits to be used in calculating the sub-pixel values.

Also, in the fourth aspect of the present invention, the motion compensation method may further include a bilinear filtering of raising a sub-pixel accuracy by applying bilinear filtering to the reference picture having the interpolated sub-pixels with the correspondingly derived sub-pixel values.

In this way, the increase in sub-pixel accuracy makes it possible to prevent picture quality from deteriorating during the picture coding processing and the picture decoding processing.

Note that the present invention can be realized as a motion compensation method, a motion estimation method, a moving picture coding method and a moving picture decoding method using the motion compensation method, a program causing a computer to execute these steps of the respective methods, a recording medium for storing the program, and an apparatus for performing operations according to these methods.

Further Information about Technical Background to this Application

The disclosure of EP Application No. 04016437.8 filed on Jul. 13, 2004 including specification, drawings and claims is incorporated herein by reference in its entirety.

### BRIEF DESCRIPTION OF DRAWINGS

These and other objects, advantages and features of the invention will become apparent from the following description thereof taken in conjunction with the accompanying drawings that illustrate a specific embodiment of the invention. In the Drawings:

FIG. 1 is a block diagram showing the structure of a moving picture coding apparatus;

FIG. 2 is an illustration of how a video image is divided into blocks;

FIG. 3 is an illustration of horizontal filtering for calculating a ¼ sub-pixel accuracy in the horizontal direction;

FIG. 4 is an illustration of vertical filtering for calculating a ¼ sub-pixel accuracy in the vertical direction;

FIG. 5 is an illustration of horizontal and vertical filtering for calculating a ⅛ sub-pixel accuracy;

FIG. 6 is an illustration of bilinear filtering in the diagonal direction for calculating a ⅛ sub-pixel accuracy;

FIG. 7 is a block diagram showing the configuration of a moving picture coding apparatus in the embodiment of the present invention;

FIG. 8 is a flow chart showing the motion compensation operation performed by the moving picture coding apparatus in the embodiment;

FIG. 9 is a comparison graph illustrating the difference between a coding result of a first image in the present invention and a coding result of another image obtained using a conventional method;

FIG. 10 is a comparison graph illustrating the difference between a coding result of a second image in the present invention and a coding result of another image obtained using a conventional method;

FIG. 11 is a block diagram showing the structure of a moving picture decoding apparatus in the embodiment of the present invention; and

FIG. 12 is an illustration of an interpolation method concerning the variation of the embodiment.

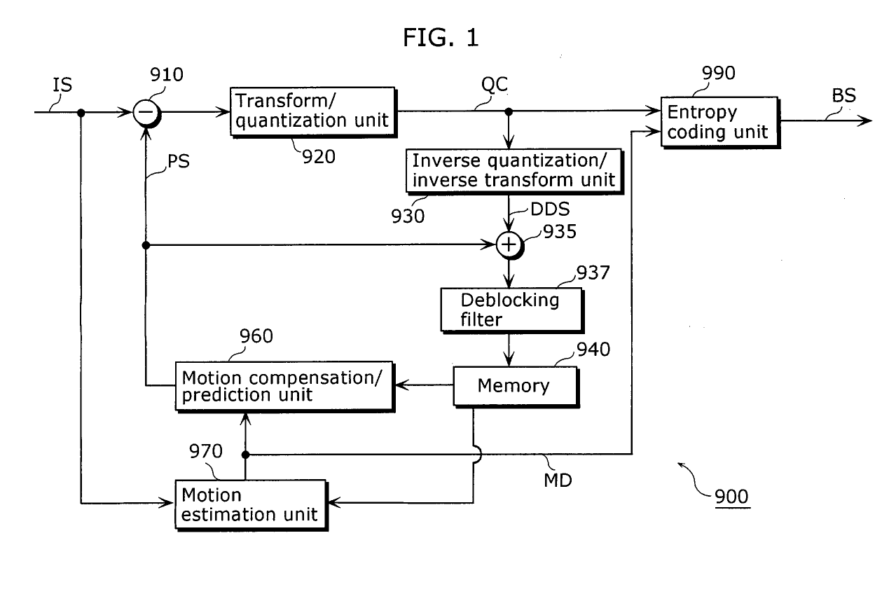

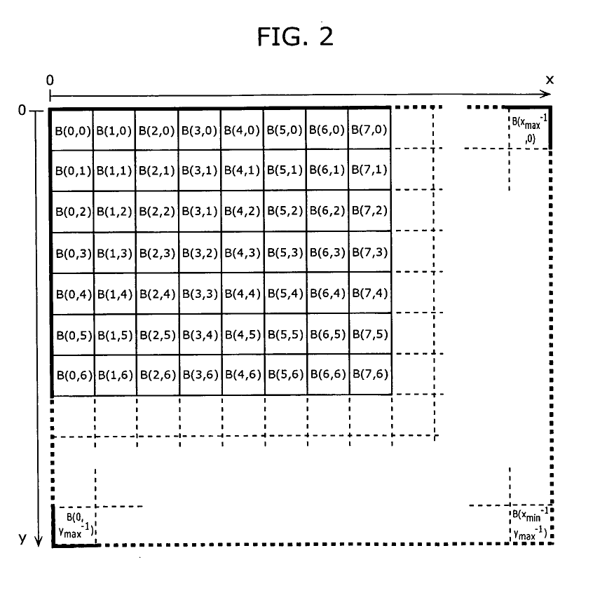

### BEST MODE FOR CARRYING OUT THE INVENTION

A moving picture coding apparatus and a moving picture decoding apparatus in the embodiment of the present invention will be described below with reference to figures.

In video coding, the coding efficiency is increased by applying motion estimation and motion compensation in predictive coding. The motion estimation and compensation can be improved by reducing the differential remaining between the image data to be coded and the predictive image data. In particular, a ⅛ sub-pixel motion vector accuracy can further improve the coding efficiency.

The present invention achieves an improved motion estimation and compensation without increasing the hardware complexity and the computational effort accordingly. This is because the present invention enables to only employ a 16-bit accuracy of intermediate calculation results for this purpose.

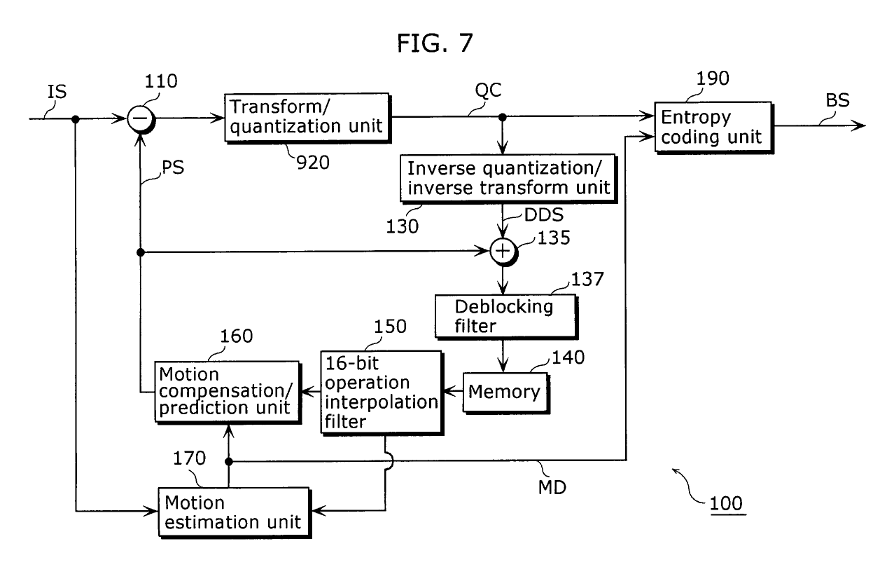

FIG. 7 is a block diagram showing the configuration of the moving picture coding apparatus in this embodiment.

This moving picture coding apparatus 100 includes: a substractor 110; a transform/quantization unit 120; an inverse quantization/inverse transform unit 130; an adder 135; a deblocking filter 137; a memory 140; a 16-bit operation interpolation filter 150; a motion compensation/prediction unit 160; a motion estimation unit 170; and an entropy coding unit 190.

The subtractor 110 subtracts a prediction signal PS from an input signal IS indicating a moving picture and outputs the differential to the transform/quantization unit 120.

The transform/quantization unit 120 obtains the differential from the subtractor 110 and performs coding processing of frequency transform (such as DCT transform) and quantization using the differential. After that, the transform/quantization unit 120 outputs the quantized transform coefficient QC that is the processing result to the entropy coding unit 190 and the inverse quantization/inverse transform unit 130.

The inverse quantization/inverse transform unit 130 performs decoding processing of inverse quantization and inverse DCT transform using the quantized transform coefficient QC outputted from the transform/quantization unit 120. After that the inverse quantization/inverse transform unit 130 outputs the differential decoding signal DDS that is the processing result to the adder 135.

The adder 135 adds the differential decoding signal DDS to the prediction signal PS obtained from the motion compensation prediction unit 160, and outputs the picture obtained as the result to the deblocking filter 137.

The deblocking filter 137 removes the block distortion of the picture outputted from the adder 135, and stores the picture with no block distortion in the memory 140 as a reference picture.

The 16-bit operation interpolation filter 150 extracts a reference picture from the memory 140 and performs ⅛ sub-pixel interpolation of the reference picture.

The motion estimation unit 170 estimates a motion vector based on the picture indicated by the input signal IS and the reference picture on which ⅛ sub-pixel interpolation has been performed using the 16-bit operation interpolation filter 150. After that, the motion estimation unit 170 outputs the motion data MD indicating the detected motion vector to the motion compensation/prediction unit 160 and the entropy coding unit 190.

The motion compensation/prediction unit 160 performs motion compensation based on the motion vector indicated by the motion data MD and the reference picture on which ⅛ sub-pixel interpolation has been performed using the 16-bit operation interpolation filter 150. In this way, the motion compensation/prediction unit 160 predicts the current picture indicated by the input signal IS and outputs the prediction signal PS indicating the prediction picture to the subtractor 110.

The entropy coding unit 190 performs entropy coding of the quantized transform coefficients QC outputted by the transform/quantization unit 120 and the motion data MD outputted by the motion estimation unit 170, and outputs the result as a bit stream BS.

The moving picture coding apparatus 100 in the embodiment like this has a feature of including a 16-bit operation interpolation filter 150. In other words, the motion compensation method in this embodiment has a feature that motion compensation is performed using the ⅛ sub-pixel interpolation by this 16-bit operation interpolation filter 150.

Note that, in the moving picture coding apparatus 100 in this embodiment, the respective functional units other than the 16-bit operation interpolation filter 150 have the same functions as the respective functional units included in the above-described conventional moving picture coding apparatus.

The 16-bit operation interpolation filter 150 calculates a ¼ sub-pixel value using a method other than a conventional method, and then calculates ⅛ sub-pixel value using the ¼ sub-pixel value like in the case of the conventional method. The method how this 16-bit operation interpolation filter 150 calculates ¼ sub-pixel value will be described in detail.

A two-step procedure is employed for obtaining the ⅛ pixel accuracy. In a first stage including two interpolation steps, a horizontal and a vertical filtering is subsequently employed. For interpolating ¼ sub-pixel values in the horizontal direction, the following Equations (11) to (13) are applied:
h₁=−1·Aₕ+3·Bₕ−10·Cₕ+59·Dₕ+18·Eₕ−6·Fₕ+1·Gₕ−0·Hₕ (11)
h₂=−1·Aₕ+4·Bₕ−10·Cₕ+39·Dₕ+39−Eₕ−10·Fₕ+4·Gₕ−1·Hₕ (12)
h₃=−0·Aₕ+1·Bₕ−6·Cₕ+18·Dₕ+59·Eₕ−10·Fₕ+3·Gₕ−1·Hₕ (13)

In the above equations, h₁ to h₃ represent the ¼ sub-pixel values to be interpolated, and Aₓ-Hₓ represent the original full-pel pixel values.

Here, the respective coefficients of Aₓ-Hₓ in this embodiment are set so that unnecessary high frequency components generated through interpolation are eliminated like in the conventional method. More specifically, the coefficients are set smaller than the conventional coefficients under the condition that picture quality does not deteriorate in the coding and decoding processing. In other words, the respective coefficients in this embodiment are set smaller in proportion to the respective coefficients of the conventional Equations (1) to (3).

After completing the horizontal filtering, the calculated values are rounded by being downshifted. For example, the intermediate value of h₁ is rounded using the following Equation (14).

$${h}_{1}^{′} = ( {h}_{1} + \frac{64}{2} ) >> 6 \qquad ( 14 )$$

Here, h₁ represents the interpolated pixel value resulting from horizontal filtering, and h₁′ represents the respectively downshifted pixel value. A corresponding processing is applied to all of the interpolated pixel values resulting from horizontal filtering. Note that “>>6” in the Equation (14) represents 6-bit downshifting.

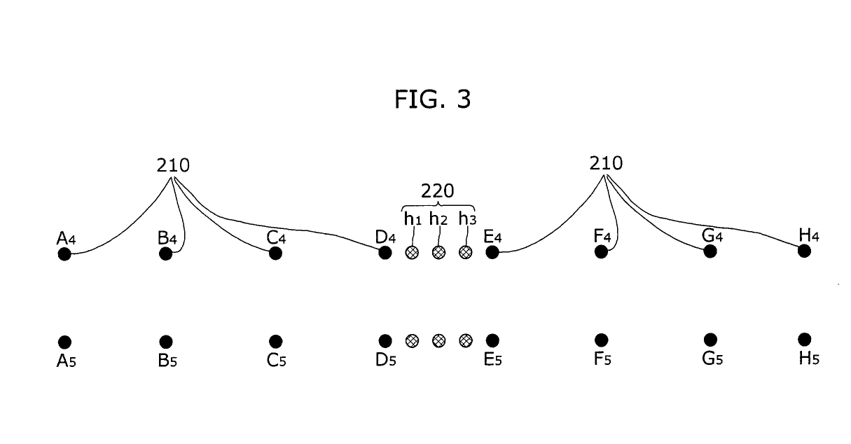

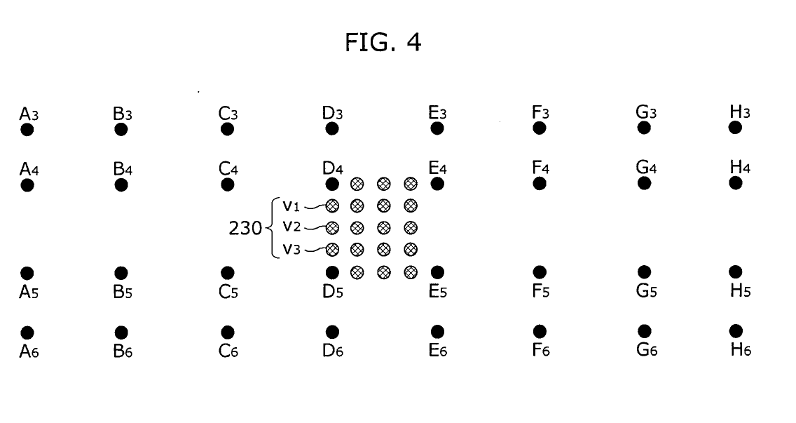

In the second step of the first stage, the horizontally increased sub-pixel accuracy is also obtained in the vertical direction. For this purpose, a vertical filtering is applied. The previously performed downshift operation provides that none of the intermediate calculations exceeds a 16-bit accuracy in the vertical filtering step. The vertical filtering is performed by employing the filter coefficients as shown in the following Equations (15) to (17) which correspond to Equations (11) to (13) in the case of the horizontal filtering:
v₁=−1·Dᵥ₋₃+3·Dᵥ₋₂−10·Dᵥ₋₁+59·Dᵥ+18·Dᵥ₊₁−6·Dᵥ₊₂+1·Dᵥ₊₃−0·Dᵥ₊₄ (15)
v₂=−1·Dᵥ₋₃+4·Dᵥ₋₂−10·Dᵥ₋₁+39·Dᵥ+39·Dᵥ₊₁−10·Dᵥ₊₂+4·Dᵥ₊₃·Dᵥ₊₄ (16)
v₃=−0·Dᵥ₋₃+1·Dᵥ₋₂−6·Dᵥ₋₁+18·Dᵥ+59·Dᵥ₊₁−10·Dᵥ₊₂+3·Dᵥ₊₃−1·Dᵥ₊₄ (17)
Here, v₁ to v₃ refer to the ¼ sub-pixel values in the vertical direction and Dᵥ₋₃, Dᵥ₋₂, Dᵥ₋₁, Dᵥ, Dᵥ₊₁, Dᵥ₊₂, Dᵥ₊₃ and Dᵥ₊₄, represent the full-pel pixels in the vertical direction. In other words, the full-pel pixels are pixels 210 and 220 from FIG. 3.

Here, the respective coefficients of Dₓ (Dᵥ₋₃ to Dᵥ₊₄) in this embodiment are set smaller in proportion to the respective coefficients of the conventional Equations (4) to (6) like in the case of the respective coefficients of the above Aₓ-Hₓ.

The calculation results from the vertical filtering, namely, pixel values 230, are subjected to downshifting by applying the following Equation (18) which is illustrated as an example case of v₁ only:

$${v}_{1}^{′} = ( {v}_{1} + \frac{64}{2} ) >> 6 \qquad ( 18 )$$

A rounding during the downshift operation is achieved by adding the value 2⁶/2=64/2 to the interpolated pixel value.

Although, the above description firstly applies a horizontal filtering and secondly a vertical filtering together with respective downshift operations, a skilled person in the art is aware that the horizontal and vertical operations may be exchanged to achieve the same result. Thus the vertical filtering may be performed before a horizontal filtering.

The finally obtained sub-pixel values with a ¼ sub-pixel accuracy are clipped in order to fall within a range between 0 and 255.

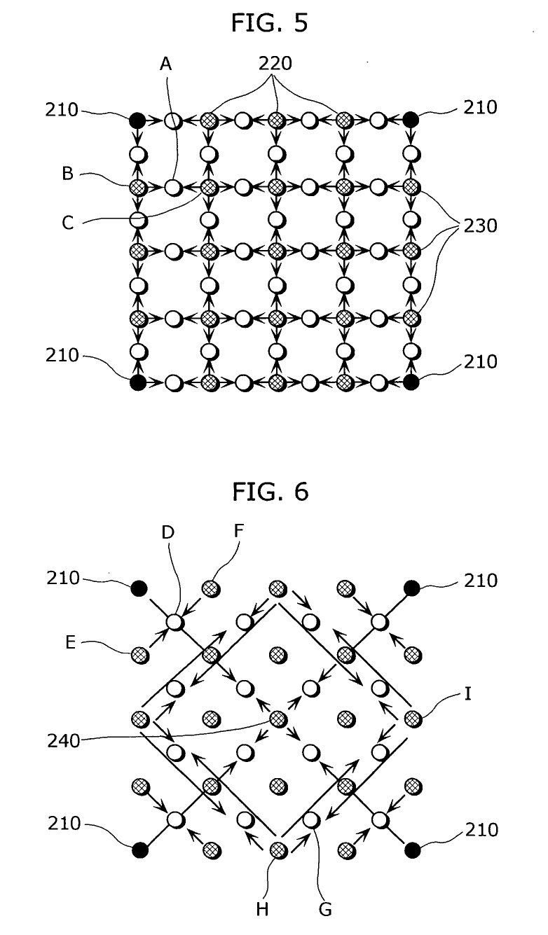

The obtained ¼ sub-pixel values are subjected to a bilinear filtering as it has been described above in connection with FIG. 5 and FIG. 6 in order to obtain a ⅛ sub-pixel resolution.

The following example demonstrates that the processing of the present invention does not require any registers for intermediate pixel values exceeding a 16-bit accuracy.

Assuming that a pixel value falls in the range between 0 and 255, the largest possible values during a horizontal 8-tap filtering may occur when employing the following Equation (19) for calculating intermediate pixel value h₂:
h₂=−1·0+4·255+(−10)·0+39·255+39·255+(−10)·0+4·255−1·0 (19)
h₂=21930<32768=2¹⁵ [symbol] 15bit+1bit(sign) (20)

In this way, this embodiment can eliminate the necessity of performing the calculation over 16 bits in the calculation processing of ¼ sub-pixel values.

The resulting pixel value is downshifted as indicated by the following Equation (21):

$$( 21930 + \frac{64}{2} ) >> 6=343 \qquad ( 21 )$$

The result of the downshift operation is clipped to the range of 0 to 255.

As demonstrated above, the required pixel accuracy for the largest possible values during the filtering operation does not exceed 16-bits. Although the above operation example has only been calculated for the horizontal direction, corresponding coefficients are used for the vertical filtering and, thus, identical advantages are applied to the vertical filtering.

The above example only relates to the ¼ sub-pixel resolution calculation. The bilinear filtering for generating a ⅛ sub-pixel resolution only requires a maximum accuracy of 10-bits. Thus, a maximum accuracy of 16-bits is sufficient for performing all calculations of the present invention. Accordingly, the motion estimation, motion compensation and the coding and decoding of data moving picture can be improved in a simple manner.

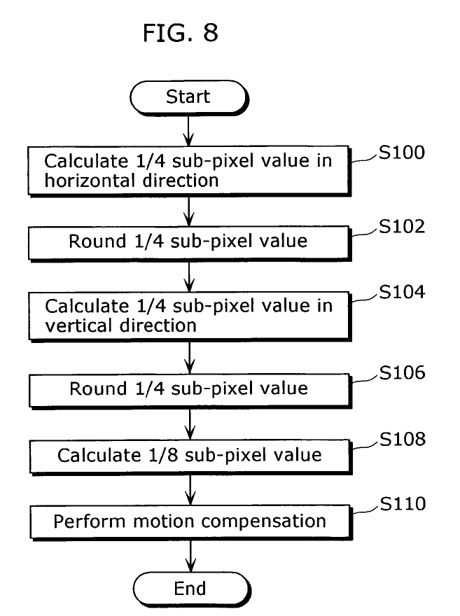

FIG. 8 is a flow chart showing the motion compensation operation performed by the moving picture coding apparatus 100 in the embodiment.

First, the 16-bit operation interpolation filter 150 of the moving picture coding apparatus 100 calculates ¼ sub-pixel values (base values which are bases of sub-pixel values) of the reference picture extracted from the memory 140 in the horizontal direction (S100). After that, the 16-bit operation interpolation filter 150 performs downshifting of the pixel values obtained in Step 100, and rounds the pixel values (Step 102).

Next, the 16-bit operation interpolation filter 150 calculates ¼ sub-pixel values in the vertical direction using the pixel values rounded in Step 102 (Step 104). After that, the 16-bit operation interpolation filter 150 performs downshifting of the pixel values obtained in Step 104 and rounds the pixel values (Step 106).

Through the operation of Step 100 to Step 106 like this, ¼ sub-pixels of the reference picture are interpolated in the horizontal direction and the vertical direction.

When ¼ sub-pixels are interpolated, the 16-bit operation interpolation filter 150 calculates ⅛ sub-pixels by performing bilinear filtering using the interpolated ¼ sub-pixels like in the conventional case, in other words, the 16-bit operation interpolation filter 150 raises the pixel accuracy of the reference picture from ¼ sub-pixel accuracy to ⅛ sub-pixel accuracy (Step 108).

Through Step 100 to Step 108 performed by the 16-bit operation interpolation filter 150 like this, a reference picture with interpolated ⅛ sub-pixel values is generated.

After that, the motion compensation/prediction unit 160 performs motion compensation using the reference picture with interpolated ⅛ sub-pixels and outputs the prediction signal PS indicating the result (Step 110).

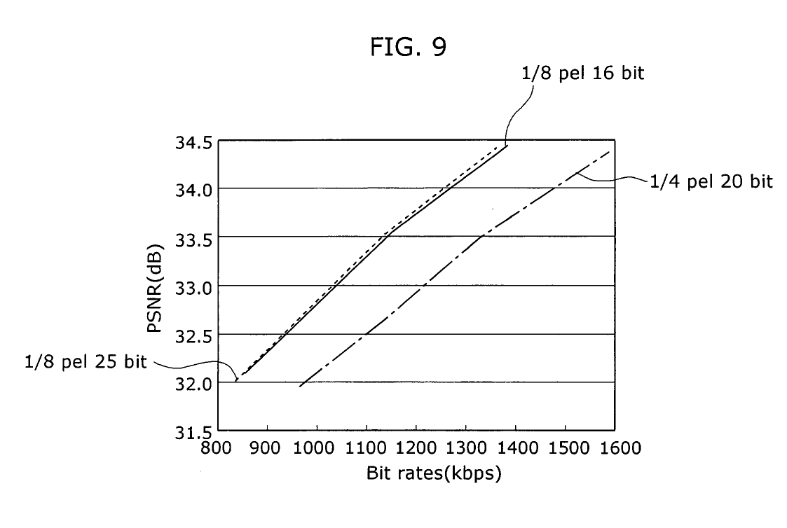

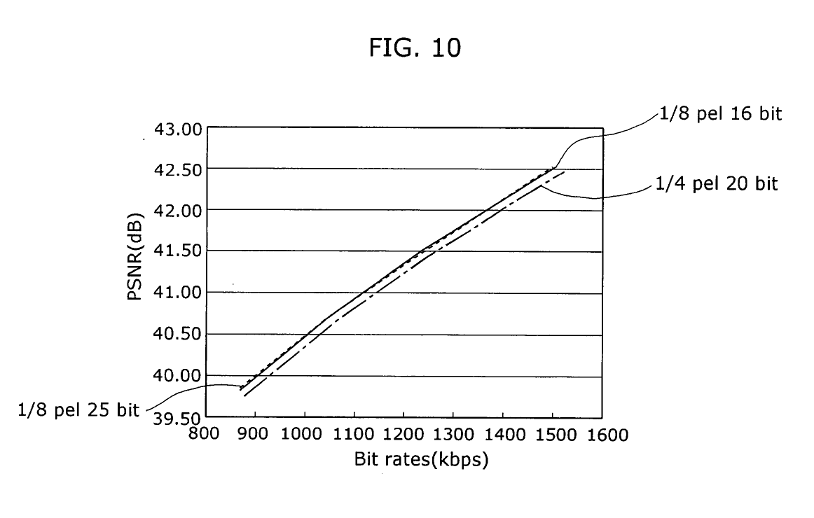

For demonstrating that similar results compared to conventional interpolation implementations can be achieved when applying the present invention, the algorithm of the present invention has been implemented into the H. 264/MPEG encoder processing software (JM4.2). The calculation results are illustrated in FIG. 9 and FIG. 10 by rate distortion curves indicating the impact on the perceived picture quality. Both figures differ only because different image sequences are employed as examples.

The rate distortion curves of FIG. 9 and FIG. 10 are shown over the bit rate on the X-axis and the peak signal to noise ratio (PSNR) on the Y-axis representing a measure for the introduced distortions.

FIG. 9 and FIG. 10 demonstrate that the 16-bit implementation of a ⅛ sub-pixel filter (⅛-pel 16 bit) does not result in an image quality degradation compared to the conventional JM4.2 algorithm (⅛-pel 25-bit) although the JM4.2 algorithm requires longer registers. In addition, the approach of the present invention actually performs better than ¼ sub-pixel 20-bit coding (¼-pel 20 bit).

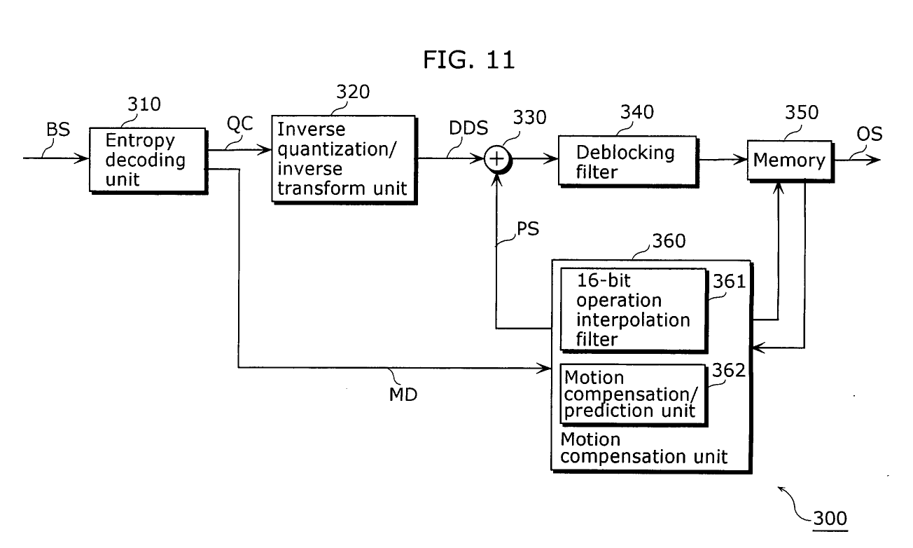

FIG. 11 is a block diagram showing the configuration of a moving picture decoding apparatus in the embodiment of the present invention.

This moving picture decoding apparatus 300 includes: an entropy decoding unit 310; an inverse quantization/inverse transform unit 320; an adder 330; a deblocking filter 340; a memory 350 and a motion compensation unit 360.

The entropy decoding unit 310 obtains a bit stream BS outputted by the moving picture coding apparatus 100 and performs entropy decoding processing of the bit stream. As the result, the entropy decoding unit 310 outputs the quantized transform coefficients QC to the inverse quantization/inverse transform unit 320 and outputs the motion data MD indicating the motion vector to the motion compensation unit 360.

The inverse quantization/inverse transform unit 320 performs decoding processing of inverse quantization and inverse DCT transform using the quantized transform coefficients QC. After that, the inverse quantization/inverse transform unit 320 outputs the differential decoding signal DDS that is the result of the processing to the adder 330.

The adder 330 adds the differential decoding signal DDS to the prediction signal PS obtained from the motion compensation unit 360, and outputs the resulting picture to the deblocking filter 340.

The deblocking filter 340 eliminates the block distortion of the picture outputted from the adder 330, and stores the picture with no block distortion to the memory 350. The decoded picture is extracted from the memory 350 as the output signal OS.

The motion compensation unit 360 includes: a 16-bit operation interpolation filter 361 for extracting the picture stored in the memory 350 as a reference picture and performing ⅛ sub-pixel interpolation of the reference picture; and a motion compensation prediction unit 361 for predicting the current picture. This motion compensation prediction unit 361 performs motion compensation based on the motion vector indicated by the motion data MD and the reference picture on which ⅛ sub-pixel interpolation is performed using a 16-bit operation interpolation filter 361. In this way, the motion compensation/prediction unit 361 predicts the current picture and outputs the prediction signal PS indicating the prediction picture to the adder 330.

The moving picture decoding apparatus 300 like this also has a feature of including a 16-bit operation interpolation filter 361 like in the case of the moving picture coding apparatus 100. This 16-bit operation interpolation filter 361 has the same function as the 16-bit operation interpolation filter 150 of the moving picture coding apparatus 100. Therefore, with this moving picture decoding apparatus 300, it is possible to reduce operation workload and simplify a hardware configuration without using pixel values exceeding 16 bits in the process of calculating the pixel values.

Summarizing, the present invention provides an improved motion estimation and compensation by only employing a simplified hardware configuration and less computational effort. This is achieved by employing particular filter coefficients and additional downshift operations when obtaining a ¼ sub-pixel resolution image. Accordingly, a more efficient coding and decoding with a simpler hardware configuration can be achieved.

(Variation)

Here, an variation of the method for interpolating ¼ sub-pixel values in the embodiment will be described below.

In the above-described embodiment, a two-step interpolation is performed in the following way: ¼ sub-pixel values are interpolated in the horizontal direction; and then other ¼ sub-pixel values are interpolated in the vertical direction. However, a single-step interpolation is performed instead of the two-step interpolation in this variation, the single-step interpolation being able to achieve the same effect as the effect obtained through both the interpolation in the horizontal direction and the vertical direction. In other words, the 16-bit operation interpolation filter 150 of this variation has a function as a two-dimensional filter.

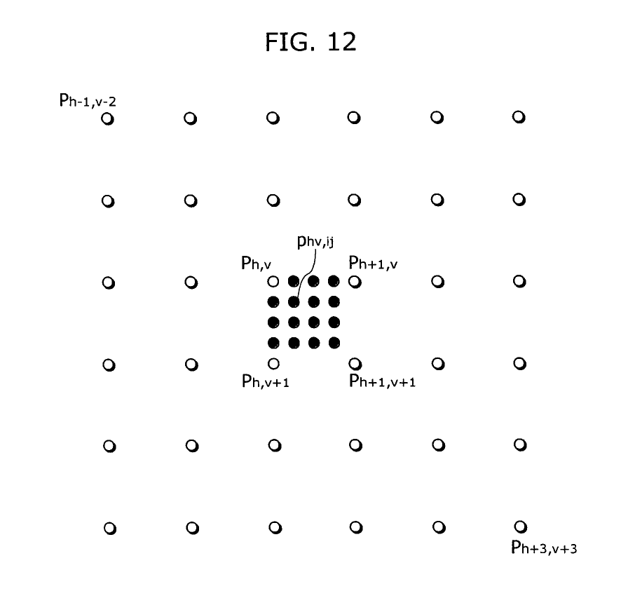

FIG. 12 is an illustration of an interpolation method concerning the variation of the embodiment.

In this FIG. 12, white circles show pixels of full pixel unit that are present in a reference picture, and the pixel values of the pixels that are present in the horizontal position h and the vertical position v are represented as P_{h,v}. Also, the number of taps of the two-dimensional filter is 36 (6 taps in both the horizontal direction and the vertical direction).

In this case, the 16-bit operation interpolation filter 150 calculates pixel values P_{hv, ij} (i, i=0 to 3, excluding “i=0 and j=0”) of sub-pixels to be interpolated using the following Equation (22). Here, cᵢⱼ (m, n) is a filter coefficients (m, n=−2 to 3) and generally vary depending on the position (i, j) of the pixel to be interpolated. After that, the sub-pixel values calculated in this way are downshifted.

$${p}_{hv , ij} = {\sum }_{m = - 2}^{3} {\sum }_{n = - 2}^{3} {c}_{ij} ( m , n ) {P}_{h + m , y - n} \qquad ( 22 )$$

In this variation like the case of the conventional example, those calculated sub-pixel values are always rounded and not used for calculating the pixel values of other sub-pixels. Thus, it is possible to reduce the number of bits necessary for the calculation process of sub-pixels.

Although only an exemplary embodiment of this invention has been described in detail above, those skilled in the art will readily appreciate that many modifications are possible in the exemplary embodiment without materially departing from the novel teachings and advantages of this invention. Accordingly, all such modifications are intended to be included within the scope of this invention.

### INDUSTRIAL APPLICABILITY

The motion compensation method concerning the present invention provides the following two effects that: operation workload can be reduced; and a hardware configuration can be simplified. For example, the motion compensation method can be applied for a moving picture coding apparatus for coding a moving picture, a moving picture decoding apparatus for decoding the coded moving picture, and the like.

1. A motion compensation method comprising:
interpolating sub-pixels in a reference picture; and
performing motion compensation based on the interpolated reference picture,
wherein said interpolating includes:
a first calculation step of calculating base values which are bases of sub-pixel values of the sub-pixels by multiplying coefficients with pixel values of pixels included in the reference picture; and
a first rounding step of deriving the sub-pixel values of the sub-pixels by rounding the base values calculated in said first calculation step instead of directly using the base values in calculating sub-pixel values of other sub-pixels, and
said performing of motion compensation includes
performing motion compensation based on the reference picture having the interpolated sub-pixels with the correspondingly derived sub-pixel values.

2. The motion compensation method according to claim 1,
wherein said first calculation step includes calculating base values of sub-pixels to be interpolated in a first direction, and
said first rounding step includes deriving sub-pixel values of the sub-pixels to be interpolated in the first direction by rounding the base values calculated in said first calculation step.

3. The motion compensation method according to claim 2,
wherein said interpolation further includes:
a second calculation step of calculating, using the sub-pixel values of the sub-pixels derived in said first rounding step, base values of sub-pixels to be interpolated in a second direction that is different from the first direction; and
a second rounding step of deriving the sub-pixel values of the sub-pixels to be interpolated in the second direction by rounding the base values calculated in said second calculation step.

4. The motion compensation method according to claim 3,
wherein said first calculation step includes calculating three base values of a-fourths sub-pixels that are arrayed in the second direction, and
said second calculation step includes calculating three base values of a-fourths sub-pixels that are arrayed in the second direction.

5. The motion compensation method according to claim 4,
wherein said first calculation step includes calculating the base values of three a-fourths sub-pixels using the following equations when eight pixel values of pixels arrayed in the first direction are represented as A, B, C, D, E, F, G and H respectively and the three a-fourths sub-pixel values are represented as h₁, h₂ and h₃ respectively:
h₁=−1·A+3·B−10·C+59·D+18·E−6·F+1·G−0·H;
h₂=−1·A+4·B−10·C+39·D+39·E−10·F+4·G−1·H; and
h₃=−0·A+1·B−6·C+18D+59E−10·F+3·G−1·H.

6. The motion compensation method according to claim 5,
wherein said second calculation step includes calculating the base values of three a-fourths sub-pixels using the following equations when eight pixel values of pixels arrayed in the second direction are represented as D₁, D₂, D₃, D₄, D₅, D₆, D₇ and D₈ respectively and the three a-fourths sub-pixel values are represented as v₁, v₂ and v₃ respectively:
v₁=−3·D₁+12·D₂−37·D₃+229·D₄+71·D₅−21·D₆+6·D₇−1·D₈;
v₂=−3·D₁+12·D₂−39·D₃+158·D₄+158·D₅−39·D₆+12·D₇−3·D₈; and
v₃=−1·D₁+6·D₂−21·D₃+71·D₄+229·D₅−37·D₆+12·D₇−3·D₈.

7. The motion compensation method according to claim 6,
wherein said first calculation step includes calculating base values of the sub-pixels to be interpolated in a horizontal direction, the horizontal direction being determined as the first direction, and
said second calculation step includes calculating base values of the sub-pixels to be interpolated in a vertical direction, the vertical direction being determined as the second direction.

8. The motion compensation method according to claim 4, further comprising
a bilinear filtering of raising a sub-pixel accuracy by applying bilinear filtering to the reference picture having the interpolated sub-pixels with the correspondingly derived sub-pixel values.

9. The motion compensation method according to claim 8,
wherein said bilinear filtering includes raising the sub-pixel accuracy of the reference picture from a a-fourths sub-pixel accuracy to an a-eighths sub-pixel accuracy.

10. The motion compensation method according to claim 1,
wherein said first rounding step includes rounding the base values of the sub-pixels by means of downshifting.

11. The motion compensation method according to claim 1,
wherein said first calculation step includes calculating base values of sub-pixels that should be arrayed in a horizontal direction and in a vertical direction by multiplying coefficients with pixel values of pixels included in the reference picture.

12. A motion estimation method comprising:
interpolating sub-pixels in a reference picture; and
performing motion estimation based on the interpolated reference picture,
wherein said interpolating includes:
a calculation step of calculating base values which are bases of sub-pixel values of the sub-pixels by multiplying coefficients with pixel values of pixels included in the reference picture; and
a rounding step of deriving the sub-pixel values of the sub-pixels by rounding the base values calculated in said calculation step instead of directly using the base values in calculating sub-pixel values of other sub-pixels, and
said performing of motion estimation includes
performing motion estimation based on the reference picture having the interpolated sub-pixels with the correspondingly derived sub-pixel values.

13. A moving picture coding method comprising:
obtaining a picture to be coded;
interpolating sub-pixels in a reference picture;
performing motion compensation based on the interpolated reference picture; and
coding a picture based on the reference picture,
wherein said interpolating includes:
a calculation step of calculating base values which are bases of sub-pixel values of the sub-pixels by multiplying coefficients with pixel values of pixels included in the reference picture; and
a rounding step of deriving the sub-pixel values of the sub-pixels by rounding the base values calculated in said calculation step instead of directly using the base values in calculating sub-pixel values of other sub-pixels, and
said performing of motion compensation includes
performing motion compensation of the picture based on the reference picture having the interpolated sub-pixels with the correspondingly derived sub-pixel values, and
said coding includes
coding a differential between the picture to be coded that has been obtained in said picture obtaining and the reference picture of which motion compensation has been performed in said performing of motion compensation.

14. A moving picture decoding method comprising:
obtaining a differential picture that is a resultant from coding the differential between a picture and another picture;
interpolating sub-pixels in a reference picture;
performing motion compensation based on the interpolated reference picture; and
decoding a coded picture based on a reference picture
wherein said interpolating includes:
a calculation step of calculating base values which are bases of sub-pixel values of sub-pixels by multiplying coefficients with pixel values of pixels included in the reference picture; and
a rounding step of deriving the sub-pixel values of the sub-pixels by rounding the base values calculated in said calculation step instead of directly using the base values in calculating sub-pixel values of other sub-pixels,
said performing of motion compensation includes
performing motion compensation of the picture based on the reference picture having the interpolated sub-pixels with the correspondingly derived sub-pixel values, and said decoding includes
decoding the differential picture obtained in said differential picture obtaining and adding the decoded differential picture to the reference picture of which motion compensation has been performed in said performing of motion compensation.

15. A motion compensation apparatus comprising:
an interpolation unit operable to interpolate sub-pixels in a reference picture; and
a motion compensation unit operable to perform motion compensation based on the interpolated reference picture,
wherein said interpolation unit includes:
a calculation unit operable to calculate base values which are bases of sub-pixel values of the sub-pixels by multiplying coefficients with pixel values of pixels included in the reference picture; and
a rounding unit operable to derive the sub-pixel values of the sub-pixels by rounding the base values calculated by said calculation unit instead of directly using the base values in calculating sub-pixel values of other sub-pixels, and
said motion compensation unit is operable to perform motion compensation of the picture based on the reference picture having the interpolated sub-pixels with the correspondingly derived sub-pixel values.

16. A motion estimation apparatus comprising:
an interpolation unit operable to interpolate pixels in a reference picture; and
an motion estimation unit operable to perform motion compensation based on the interpolated reference picture,
wherein said interpolation unit includes:
a calculation unit operable to calculate base values which are bases of sub-pixel values of sub-pixels by multiplying coefficients with pixel values of pixels included in the reference picture; and
a rounding unit operable to derive the sub-pixel values of the sub-pixels by rounding the base values calculated by said calculation unit instead of directly using the base values in calculating sub-pixel values of other sub-pixels, and
said motion estimation unit is operable to perform motion estimation based on the reference picture having the interpolated sub-pixels with the correspondingly derived sub-pixel values.

17. A moving picture coding apparatus comprising:
a picture obtainment unit operable to obtain the picture to be coded;
an interpolation unit operable to interpolate sub-pixels in a reference picture;
a motion compensation unit operable to perform motion compensation based on the interpolated reference picture; and
a coding unit operable to code a picture based on a reference picture,
wherein said interpolation unit includes:
a calculation unit operable to calculate base values which are bases of sub-pixel values of the sub-pixels by multiplying coefficients with pixel values of pixels included in the reference picture; and
a rounding unit operable to derive the sub-pixel values of the sub-pixels by rounding the base values calculated by said calculation sub-unit instead of directly using the base values in calculating pixel values of other sub-pixels,
said motion compensation unit is operable to perform motion compensation of the picture based on the reference picture having the interpolated sub-pixels with the correspondingly derived sub-pixel values, and
said coding unit is operable to code a differential between the picture to be coded that has been obtained by said picture obtainment unit and the reference picture of which motion compensation has been performed by said motion compensation unit.

18. A moving picture decoding apparatus comprising:
a differential picture obtainment unit operable to obtain a differential picture that is a resultant from coding the differential between a picture and another picture;
an interpolation unit operable to interpolate sub-pixels in a reference picture;
a motion compensation unit operable to perform motion compensation based on the interpolated reference picture; and
a decoding unit operable to decode a coded picture based on a reference picture,
wherein said interpolation unit includes:
a calculation unit operable to calculate base values which are bases of sub-pixel values of sub-pixels by multiplying coefficients with pixel values of pixels included in the reference picture; and
a rounding unit operable to derive the sub-pixel values of the sub-pixels by rounding the base values calculated by said calculation unit instead of directly using the base values in calculating sub-pixel values of other sub-pixels,
said motion compensation unit is operable to perform motion compensation of the picture based on the reference picture having the interpolated sub-pixels with the correspondingly derived sub-pixel values, and
said decoding unit is operable to decode the differential picture obtained by said differential picture obtainment unit and operable to add the decoded differential picture to the reference picture of which motion compensation has been performed by said motion compensation unit.

19. A motion compensation program for causing a computer to execute interpolating sub-pixels in a reference picture and performing motion compensation based on the interpolated reference picture,
wherein said interpolating includes:
a calculation step of calculating base values which are bases of sub-pixel values of the sub-pixels by multiplying coefficients with pixel values of pixels included in the reference picture; and
a rounding step of rounding the base values of the sub-pixel values calculated in said calculation step instead of directly using the base values in calculating sub-pixel values of other sub-pixels, and
said performing of motion compensation includes
performing motion compensation of the picture based on the reference picture having the interpolated sub-pixels with the correspondingly derived sub-pixel values.
